(19) United States
(12) Patent Application Publication
(10) Pub. No.: US 2026/0200481 A1
(43) Pub. Date: Jul. 16, 2026

(54) MULTIPLE SENSOR VALIDATION SYSTEMS AND METHODS

(71) Applicant: GM GLOBAL TECHNOLOGY OPERATIONS LLC, Detroit, MI (US)

(72) Inventor: Wenyuan QI, Shanghai (CN)

(21) Appl. No.: 19/443,902

(22) Filed: Jan. 8, 2026

(30) Foreign Application Priority Data
Jan. 14, 2025 (CN) 2025100559150

(51) Int. Cl. B60W 50/02; B60W 10/06; B60W 10/08; B60W 10/18; B60W 10/20; B60W 10/30; B60W 50/00; G06T 15/20; G06V 20/58

(52) U.S. Cl. CPC B60W 50/0205; B60W 10/06; B60W 10/08; B60W 10/18; B60W 10/20; B60W 10/30; B60W 50/0097; G06T 15/20; B60W 2554/404; G06V 20/58

(57) ABSTRACT

An exterior sensor system includes: an input module configured to input sensor data of an external sensor of a vehicle, the external sensor configured to sense a space outside of the vehicle; a latent space module configured to generate a three dimensional (3D) space representation of the space based on the input sensor data; a latent representation module configured to generate a latent 3D representation of the space based on the 3D space representation and using a 3D model; a prediction module configured to generate one or more predictions for one or more respective times based on the input sensor data; a rendering module configured to generate one or more renderings of the space based on the latent 3D representation and the one or more predictions; and a fault module configured to indicate whether a fault is present in the external sensor based on the one or more renderings.

### CROSS-REFERENCE TO RELATED APPLICATIONS

This application claims the benefit of Chinese Patent Application No. 202510055915.0, filed on Jan. 14, 2025. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle sensors and cameras and more particularly to systems and methods for validating performance of vehicle sensors and cameras.

Vehicles include one or more torque producing devices, such as an internal combustion engine and/or an electric motor. A passenger of a vehicle rides within a passenger cabin (or passenger compartment) of the vehicle.

Vehicles may include one or more different types of sensors that sense vehicle surroundings. One example of a sensor that senses vehicle surroundings is a camera configured to capture images of the vehicle surroundings. Examples of such cameras include forward-facing cameras, rear-facing cameras, and side facing cameras. Another example of a sensor that senses vehicle surroundings includes a radar sensor configured to capture information regarding vehicle surroundings. Other examples of sensors that sense vehicle surroundings include sonar sensors and light detection and ranging (LIDAR) sensors configured to capture information regarding vehicle surroundings.

### SUMMARY

In a feature, an exterior sensor system for a vehicle includes: an input module configured to input sensor data of an external sensor of the vehicle, the external sensor configured to sense a space outside of the vehicle; a latent space module configured to generate a three dimensional (3D) space representation of the space based on the input sensor data; a latent representation module configured to generate a latent 3D representation of the space based on the 3D space representation and using a 3D model; a prediction module configured to generate one or more predictions for one or more respective times based on the input sensor data; a rendering module configured to generate one or more renderings of the space based on the latent 3D representation and the one or more predictions; and a fault module configured to indicate whether a fault is present in the external sensor based on the one or more renderings.

In further features, the input sensor data includes raw data for the external sensor and metadata for the external sensor.

In further features, the metadata includes a configuration of the external sensor and a specification of the external sensor.

In further features, the 3D space representation is ambient condition independent.

In further features, the 3D space representation is sensor independent.

In further features, the 3D space representation is a matrix.

In further features, the rendering module is configured to generate the one or more renderings further based on metadata for the external sensor.

In further features, the metadata includes a location of the external sensor.

In further features, the metadata includes a gesture of the external sensor.

In further features, a recognition module of the external sensor is configured to recognize objects in the one or more renderings.

In further features, the recognition module is configured to recognize objects in the one or more renderings without additional pre-processing of the one or more renderings before the object recognition.

In further features, a dynamic data module is configured to generate dynamic data based on the one or more renderings.

In further features, the dynamic data module is configured to generate the dynamic data further based on a file including dynamic content for at least one of (a) a driving scenario and (b) a traffic scenario.

In further features, the file includes an OpenSCENARIO extensible markup language (XML) file.

In further features, an object tracking module of the external sensor is configured to track objects using the dynamic data.

In further features: the input module is further configured to input second sensor data of a second external sensor of the vehicle, the second external sensor configured to sense the space outside of the vehicle; the latent space module is further configured to generate a second 3D space representation of the space based on the second input sensor data; the latent representation module is further configured to generate a second latent 3D representation of the space based on the second 3D space representation and using the 3D model; the prediction module is further configured to generate one or more second predictions for the one or more respective times based on the second input sensor data; the rendering module is further configured to generate one or more second renderings of the space based on the second latent 3D representation and the one or more second predictions; and the fault module is further configured to, concurrently with indicating whether the fault is present in the external sensor, indicate whether a second fault is present in the second external sensor based on the one or more second renderings.

In further features, at least one of the following is included: a steering control module configured to selectively adjust steering of the vehicle based on the one or more renderings; an engine control module configured to selectively adjust torque output of an engine of the vehicle based on the one or more renderings; a brake control module configured to selective adjust braking of the vehicle based on the one or more renderings; and an inverter module configured to selectively adjust torque output of an electric motor based on the one or more renderings.

In further features, the fault module is configured to indicate that the fault is present in the external sensor when an output of the external sensor generated based on the one or more renderings is different than a predetermined expected output of the external sensor.

In a feature, an exterior sensor system for a vehicle includes: an input module configured to input sensor data of an external sensor of the vehicle, the external sensor configured to sense a space outside of the vehicle; a latent space module configured to generate a three dimensional (3D) space representation of the space based on the input sensor data; a latent representation module configured to generate a latent 3D representation of the space based on the 3D space representation and using a 3D model; a prediction module configured to generate one or more predictions for one or more respective times based on the input sensor data; a rendering module configured to generate one or more renderings of the space based on the latent 3D representation and the one or more predictions; a fault module configured to indicate whether a fault is present in the external sensor based on the one or more renderings, where the input sensor data includes raw data for the external sensor and metadata for the external sensor, where the 3D space representation is ambient condition independent and sensor independent, where the rendering module is configured to generate the one or more renderings further based on metadata for the external sensor; a recognition module of the external sensor, the recognition module configured to recognize objects in the one or more renderings; a dynamic data module configured to generate dynamic data based on the one or more renderings, where the dynamic data module is configured to generate the dynamic data further based on a file including dynamic content for at least one of (a) a driving scenario and (b) a traffic scenario; an object tracking module of the external sensor, the object tracking module configured to track objects using the dynamic data; and at least one of: a steering control module configured to selectively adjust steering of the vehicle based on the one or more renderings; an engine control module configured to selectively adjust torque output of an engine of the vehicle based on the one or more renderings; a brake control module configured to selective adjust braking of the vehicle based on the one or more renderings; and an inverter module configured to selectively adjust torque output of an electric motor based on the one or more renderings.

In a feature, an exterior sensor method for a vehicle includes: receiving sensor data of an external sensor of the vehicle, the external sensor configured to sense a space outside of the vehicle; generating a three dimensional (3D) space representation of the space based on the input sensor data; generating a latent 3D representation of the space based on the 3D space representation and using a 3D model; generating one or more predictions for one or more respective times based on the input sensor data; generating one or more renderings of the space based on the latent 3D representation and the one or more predictions; and indicating whether a fault is present in the external sensor based on the one or more renderings.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a functional block diagram of a vehicle including various external cameras and sensors;

FIG. 3 is a functional block diagram of an example implementation of a validation system including a validation module;

FIG. 4 is a functional block diagram of an example fault diagnostic system; and

FIG. 5 is a flowchart depicting an example method of testing the sensor(s) under test.

In the drawings, reference numbers may be reused to identify similar and/or identical elements.

### DETAILED DESCRIPTION

A vehicle may include a camera configured to capture images within a predetermined field of view (FOV) around an exterior of the vehicle. A perception module may perceive objects around the vehicle and determine locations of the objects. For example, a camera may be used to capture images including a road in front of the vehicle. Lane lines and objects around the vehicle can be identified using images from the camera and one or more other cameras and/or sensors. Functionality of external cameras and sensors of a vehicle could be tested using real-world testing while operating the vehicle on a road.

Three dimensional (3D) environment based sensor validation involve volume rendering and lightening system baking, which may be time consuming. After generating a 3D virtual environment, different sensor modeling may be used to capture the data based on the premade virtual environment. This would be time consuming as a different version would be generated for each different type of sensor. Since lightening of the 3D environment is done before hand, it may be hard to re-render weather in real time for validation.

The present application involves validating the functionality of external cameras and sensors of the vehicle using injected latent 3D representations to make validation during vehicle manufacture as accurate as real world validation. The validation discussed herein involves sensor type and ambient condition representations and time related complementary representations, which can help real time rendering based on location and status of the sensor(s) under test/validation. Multiple exterior cameras and/or sensors can be validated/tested concurrently.

A latent virtual representation of a real world scene is used considering different sensor types during the data training. The latent space of the trained model can flexibly represent objects' attributes based on different types of sensor metadata. This can speed up the generation of data injection for sensor validation and lightening can be added during validation runtime. The virtual environment is generated to be friendly and easily captured by the sensors. time related prediction may help generate novel view data and help data injection with a background buffer estimation in order to make the validation perform in real-time.

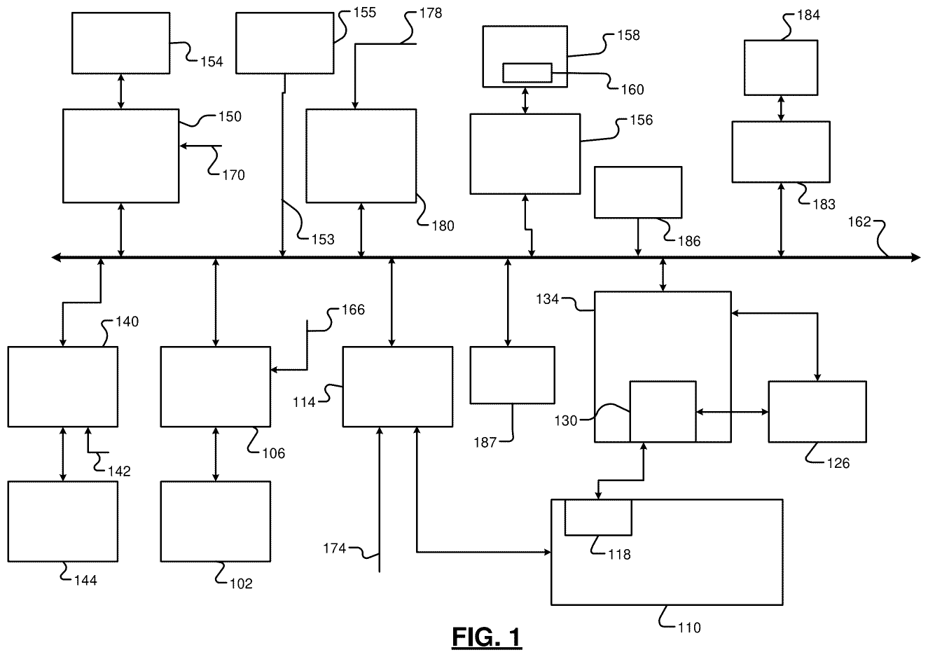

Referring now to FIG. 1, a functional block diagram of an example vehicle system is presented. While a vehicle system for a hybrid vehicle is shown and will be described, the present application is also applicable to non-hybrid vehicles, electric vehicles, fuel cell vehicles, and other types of vehicles. The present application is applicable to autonomous vehicles, semi-autonomous vehicles, non-autonomous vehicles, shared vehicles, non-shared vehicles, and other types of vehicles.

An engine 102 may combust an air/fuel mixture to generate drive torque. An engine control module (ECM) 106 controls the engine 102. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators. In some types of vehicles (e.g., electric vehicles), the engine 102 may be omitted.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system may include one or more electric motors. For example, an electric motor 118 may be implemented within the transmission 110 as shown in the example of FIG. 1. An electric motor can act as either a generator or as a motor at a given time. When acting as a generator, an electric motor converts mechanical energy into electrical energy. The electrical energy can be, for example, used to charge a battery 126 via a power control device (PCD) 130. When acting as a motor, an electric motor generates torque that may be used, for example, to supplement or replace torque output by the engine 102. While the example of one electric motor is provided, the vehicle may include zero or more than one electric motor.

A power inverter module (PIM) 134 may control the electric motor 118 and the PCD 130. The PCD 130 applies power from the battery 126 to the electric motor 118 based on signals from the PIM 134, and the PCD 130 provides power output by the electric motor 118, for example, to the battery 126. The PIM 134 may include, for example, an inverter.

A steering control module 140 controls steering/turning of wheels of the vehicle, for example, based on driver turning of a steering wheel within the vehicle and/or steering commands from one or more vehicle control modules. A steering wheel angle (SWA) sensor (not shown) monitors rotational position of the steering wheel and generates a SWA 142 based on the position of the steering wheel. As an example, the steering control module 140 may control vehicle steering via an electronic power steering (EPS) motor 144 based on the SWA 142. However, the vehicle may include another type of steering system.

A brake control module 150 may selectively control (e.g., friction) brakes 154 of the vehicle based on one or more driver inputs, such as a brake pedal position (BPP) 170. Another driver input may be a cruise control input 153 from a cruise control module 155 when cruise control is enabled.

A damper control module 156 controls damping of dampers 158 of the wheels, respectively, of the vehicle. The dampers 158 damp vertical motion of the wheels. The damper control module 156 may control, for example, damping coefficients of the dampers 158, respectively. For example, the dampers 158 may include magnetorheological dampers, continuous damping control dampers, or another suitable type of adjustable damper. The dampers 158 include actuators 160 that adjust damping of the dampers 158, respectively. In the example of magnetorheological dampers, the actuators 160 may adjust magnetic fields applied to magnetorheological fluid within the dampers 158, respectively, to adjust damping.

Modules of the vehicle may share parameters via a network 162, such as a controller area network (CAN). A CAN may also be referred to as a car area network. For example, the network 162 may include one or more data buses. Various parameters may be made available by a given module to other modules via the network 162.

The driver inputs may include, for example, an accelerator pedal position (APP) 166 which may be provided to the ECM 106. The BPP 170 may be provided to the brake control module 150. A position 174 of a park, reverse, neutral, drive lever (PRNDL) may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, or crank.

An infotainment module 183 may output various information via one or more output devices 184. The output devices 184 may include, for example, one or more displays (non-touch screen and/or touch screen), one or more other suitable types of video output devices, one or more speakers, one or more haptic devices, and/or one or more other suitable types of output devices.

The infotainment module 183 may output video via the one or more displays. The infotainment module 183 may output audio via the one or more speakers. The infotainment module 183 may output other feedback via one or more haptic devices. For example, haptic devices may be included with one or more seats, in one or more seat belts, in the steering wheel, etc. Examples of displays may include, for example, one or more displays (e.g., on a front console) of the vehicle, a head up display (HUD) that displays information via a substrate (e.g., windshield), one or more displays that drop downwardly or extend upwardly to form panoramic views, and/or one or more other suitable displays.

The vehicle may include a plurality of external sensors and cameras, generally illustrated in FIG. 1 by 186. One or more actions may be taken based on input from the external sensors and cameras 186. For example, the infotainment module 183 may display video, various views, and/or alerts on a display via input from the external sensors and cameras 186 during driving.

As another example, brake control module 150 and/or the steering control module 140 may apply the brakes 154 and/or steer the vehicle to avoid the vehicle colliding with an object around the vehicle.

The vehicle may include one or more additional control modules that are not shown, such as a chassis control module, a battery pack control module, etc. The vehicle may omit one or more of the control modules shown and discussed.

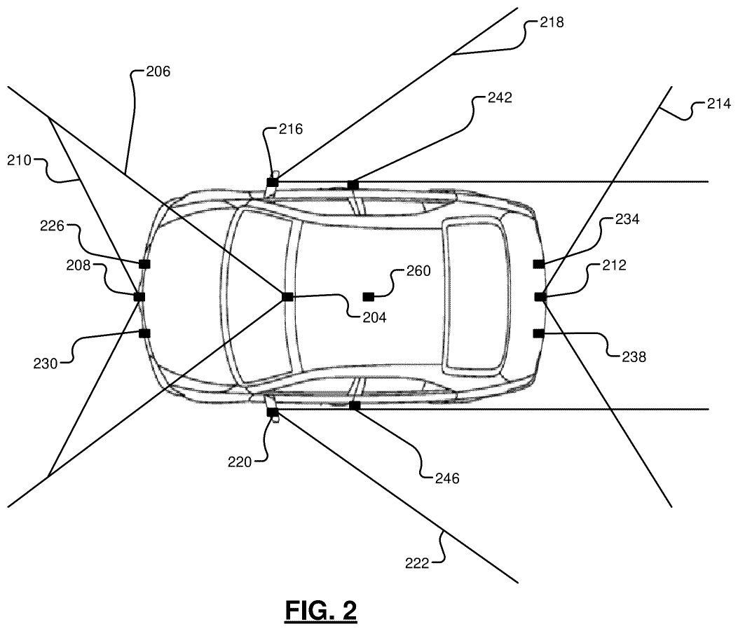

Referring now to FIG. 2, a functional block diagram of a vehicle including examples of external sensors and cameras is presented. The external sensors and cameras 186 (FIG. 1) include various cameras positioned to capture images and video outside of (external to) the vehicle and various types of sensors measuring parameters outside of (external to) the vehicle. Examples of the external sensors and cameras 186 will now be discussed. For example, a forward-facing camera 204 captures images and video of images within a predetermined field of view (FOV) 206 in front of the vehicle.

A front camera 208 may also capture images and video within a predetermined FOV 210 in front of the vehicle. The front camera 208 may capture images and video within a predetermined distance of the front of the vehicle and may be located at the front of the vehicle (e.g., in a front fascia, grille, or bumper). The forward-facing camera 204 may be located more rearward, however, such as with a rear-view mirror at a windshield of the vehicle. The forward-facing camera 204 may not be able to capture images and video of items within all of or at least a portion of the predetermined FOV of the front camera 208 and may capture images and video more than the predetermined distance of the front of the vehicle. In various implementations, only one of the forward-facing camera 204 and the front camera 208 may be included.

A rear camera 212 captures images and video within a predetermined FOV 214 behind the vehicle. The rear camera 212 may be located at the rear of the vehicle, such as near a rear license plate.

A right camera 216 captures images and video within a predetermined FOV 218 to the right of the vehicle. The right camera 216 may capture images and video within a predetermined distance to the right of the vehicle and may be located, for example, under a right side rear-view mirror. In various implementations, the right side rear-view mirror may be omitted, and the right camera 216 may be located near where the right side rear-view mirror would normally be located.

A left camera 220 captures images and video within a predetermined FOV 222 to the left of the vehicle. The left camera 220 may capture images and video within a predetermined distance to the left of the vehicle and may be located, for example, under a left side rear-view mirror. In various implementations, the left side rear-view mirror may be omitted, and the left camera 220 may be located near where the left side rear-view mirror would normally be located. While the example FOVs are shown for illustrative purposes, the present application is also applicable to other FOVs. In various implementations, FOVs may overlap, for example, for more accurate and/or inclusive stitching.

The external sensors and cameras 186 may additionally or alternatively include various other types of sensors, such as light detection and ranging (LIDAR) sensors, ultrasonic sensors, radar sensors, and/or one or more other types of sensors. For example, the vehicle may include one or more forward-facing ultrasonic sensors, such as forward-facing ultrasonic sensors 226 and 230, one or more rearward facing ultrasonic sensors, such as rearward facing ultrasonic sensors 234 and 238. The vehicle may also include one or more right side ultrasonic sensors, such as right side ultrasonic sensor 242, and one or more left side ultrasonic sensors, such as left side ultrasonic sensor 246. The vehicle may also include one or more light detection and ranging (LIDAR) sensors, such as LIDAR sensor 260. The locations of the cameras and sensors are provided as examples only and different locations could be used. Ultrasonic sensors output ultrasonic signals around the vehicle.

The external sensors and cameras 186 may additionally or alternatively include one or more other types of sensors, such as one or more sonar sensors, one or more radar sensors, and/or one or more other types of sensors. In the following, external cameras and sensors will be more simply referred to as external sensors.

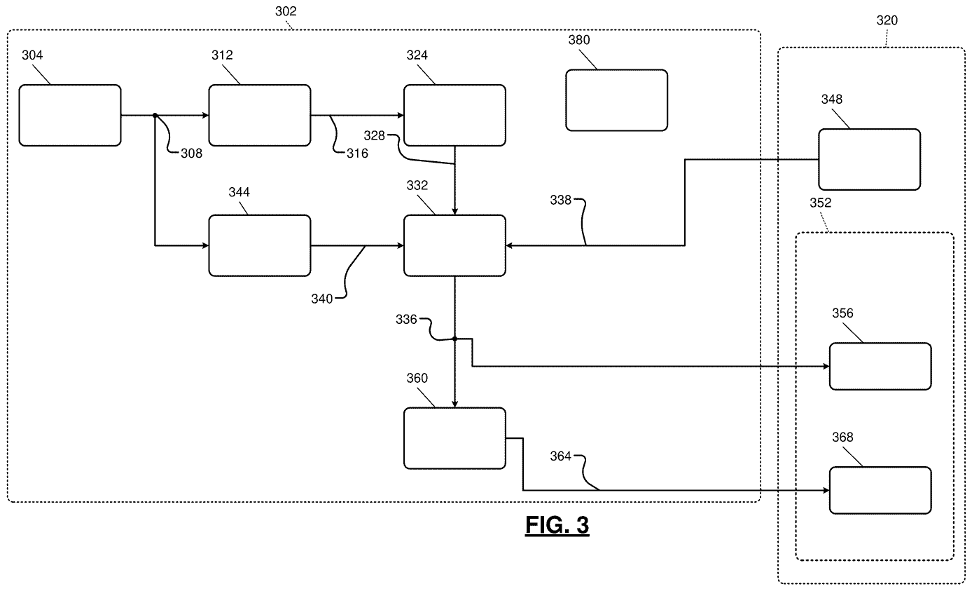

FIG. 3 is a functional block diagram of an example implementation of a validation system including a validation module 302. An input module 304 inputs sensor data and sensor metadata 308. The sensor data may include raw data for each external sensor. The sensor metadata may include a sensor configuration each external sensor and one or more predetermined specifications for each external sensor.

A latent space module 312 generates a 3D latent space 316 based on the sensor data and sensor metadata 308. The 3D latent space 316 may be sensor and ambient condition independent. The 3D latent space 316 may be a representation of a 3D space around the external sensor(s) 320 under test/validation.

A latent representation module 324 generates a latent representation 328 (e.g., matrix) of the 3D space based on the 3D latent space 316. The latent representation module 324 generates the latent representation using a 3D model.

A rendering module 332 generates one or more real time renderings 336 (e.g., rendered images) based on the latent representation 328 and one or more time related predictions 340. The rendering module 332 generates the one or more real time renderings 336 further based on sensor metadata 338 from the sensor(s) under test 320. The sensor metadata 338 may include a location and gesture (e.g., pose) for each of the sensor(s) under test 320. The time related prediction(s) 340 are complementary to the latent representation 328.

A prediction module 344 generates the time related prediction(s) 340 based on the sensor data and sensor metadata 308. A configuration module 348 of each sensor under test 320 provides its sensor metadata 338.

Each sensor under test 320 includes a processing module 352 that includes a recognition module 356. The recognition module 356 performs object recognition in the renderings 336. No additional pre-processing is performed on the renderings 336 before use by the recognition module 356 for object recognition.

A dynamic data module 360 generates a dynamic data output (e.g., rendering(s)) 364 based on the renderings 336 and a file including dynamic content of driving and/or traffic simulation. The file may be, for example, the OpenSCENARIO XML file or another suitable file.

An object tracking module 368 of the processing module 352 tracks objects detected by the recognition module 356 using the dynamic data output 364. As discussed above, multiple sensors 320 under test may be tested at the same time/concurrently.

One or more downstream tasks may be performed on the outputs (e.g., object tracks, objects recognized, etc.) of the sensors under test 320.

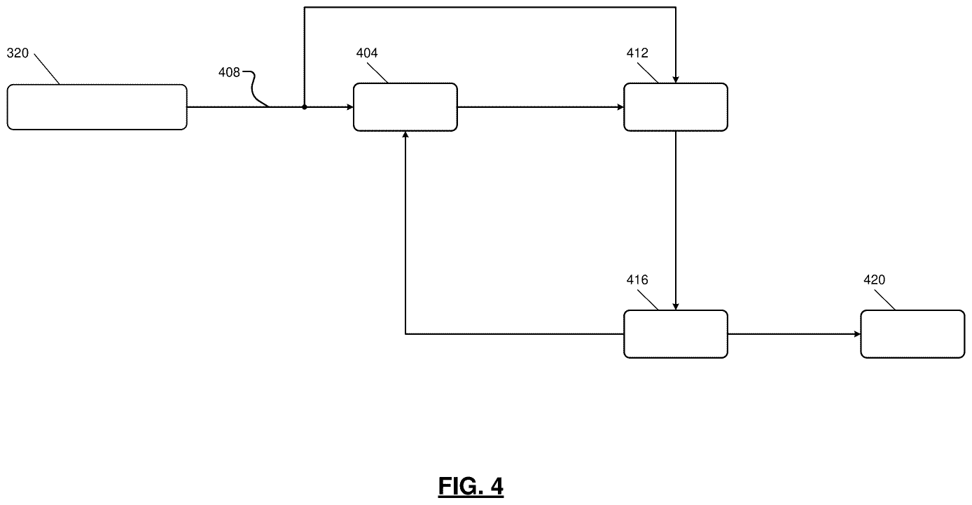

FIG. 4 is a functional block diagram of an example fault diagnostic system. A task module 404 performs one or more tasks using the output 408 of one or more of the sensors under test 320. Examples of tasks include sensor fusion, route/path planning for the vehicle, and other tasks. Sensor fusion involves combining the outputs of two or more sensors to generate a more comprehensive, detailed, and/or other view of surroundings. Vehicle propulsion and steering may be controlled by one or more of the modules of FIG. 1 to follow a planned route/path.

A fault module 412 determines whether a sensor under test 320 has a fault based on the output 408 of that sensor under test and/or performance of the task on the output 408. For example, the fault module 412 may determine that a sensor under test 320 has a fault when the output 408 of that sensor is different than a predetermined expected output. The fault module 412 may determine that a sensor under test 320 has a fault when the task performed based on the output 408 is different than a predetermined expected instance of the task.

A remedial action module 416 may perform one or more remedial actions when a fault is present in a sensor under test 320. For example, the fault module 416 may disable performance of one or more tasks performed on the output 408 when a fault is present in the sensor under test 320. Additionally or alternatively, the remedial module 416 may output one or more indicators of a fault in the sensor under test 320. For example, the remedial action module 416 may turn on or output one or more visual indicators of a fault in the sensor under test 320 (e.g., turn on an indicator 420 or output the fault on a display) and/or audibly output one or more audible indicators of a fault in the sensor under test 320 via one or more speakers.

To summarize FIG. 3, the latent space representation of virtual environment involves training. The training involves inputting by the inputting module 304 raw data (R) for different exterior sensor types. Besides that, the physical based metadata (D) of sensor capturing model are also input. The metadata includes the sensor configuration and physical specification for sensing information from surrounding environments.

The model used by the latent representation module 324 may be a neural network model and may be trained (e.g., by a training module 380) based on various objects (O) with sensor related attributes (A) from different external sensors. The objects may be static objects and predetermined traffic entities on the road, highway, and suburban areas, such as vehicles, bikes, traffic lights, traffic signs, buildings, vegetation, etc.). The sensor related attributes can include, for example, color, reflection, roughness, density with lasers, Doppler information, distance, and other attributes, which may be specific to different exterior sensors.

An example equation is as follows: {Model |(D, R, O(A))}

The trained model can be used to as described above to generate a 3D latent space environment considering the attributes of different types of sensors. (Model~Z space). This may be is a high dimension matrix (Rows and columns>a predetermined number) that also reflects the different lightening weights. In other words, the output of latent space module 312 may be matrix data that is independent against sensor type and ambient condition (e.g., lightening, weather and day/night).

The latent representation module 324 may deploy the latent objects based on the road network and predetermined static object area distribution requirements. Generally, the latent representation module 324 may conducts a location/position encoding (inner production operation) procedure based on a predetermined deployment requirement that can generate a Matrix M to represent the static traffic entities in the virtual environment specifically being used in this round of sensor validation.

The prediction module 344 may generate the time related prediction(s) using a model, such as a long short term memory (LSTM) model, to estimate the next couple timesteps based on the previous time frame. The time related predictions are used to estimate the status information of traffic entities one or more steps in the future (predictions), such as the objects occluded by others. This is another training model based on the 3D model latent representation and time series data, which is independent upon different sensors. The object tracking module 368 may track objects based on transforming the latent variable Z′ based on the distribution of latent space.

In the rendering module 332, the sensor location and gesture information can be used during the rendering to calculate accurate sensor attributes like color, reflection, roughness, density and others based on the different metadata and specification of external sensors. In various implementations, inner product of the sensor attributes and the Matrix M may be used from the latent representation module 324 to reach a most possible rendering result for the current time frame.

Furthermore, while rendering the current time frame data, a double buffer mechanism may be used to store the time related complementary results (predictions) in the background. This may speed up context switching between different timeframes. It can also help generate the rendered data based on the latent space feature against ambient condition in real-time without introducing any latency of data preprocessing (e.g., status estimation, data attribute transformation based on the condition modification).

The rendering module 332 generates a series of high-quality data with different locations and types of sensor data. The generated renderings can be directly injected into the processing module 352 without leveraging any hardware devices and preprocessing of sensor itself. Since the rendered data is already compatible, it can be used directly by the recognition module 356 to capture the key information of surrounding environments, similar to recognition for in the physical world.

In order to model the dynamic objects in the above generated environment, the OpenScenario data/file may be used to describe the location and behavior of traffic entities. The dynamic data module 360 may index the time frame of generated novel view data from latent representation virtual word, and project all the traffic entities on this view data based on the sensor information and relevant position and angle of a host vehicle. This can help naturally filter out any timely unrelated objects and there is no need to model the 3D representation for these dynamic objects. The object tracking module 368 can capture the objects surrounding the host vehicles.

The output of a validated sensor can be leveraged by one or more downstream tasks for further testing and validation. Since the attributes and sensor types are being involved in the training phase, the generated novel view data can generate the different sensor data in parallel by capturing the Matrix operation from different sensor attributes. In other words, multiple exterior sensors can be validated at the same time, which can be helpful for keeping the sensor fusion algorithm and multimodality sensor validation in the loop.

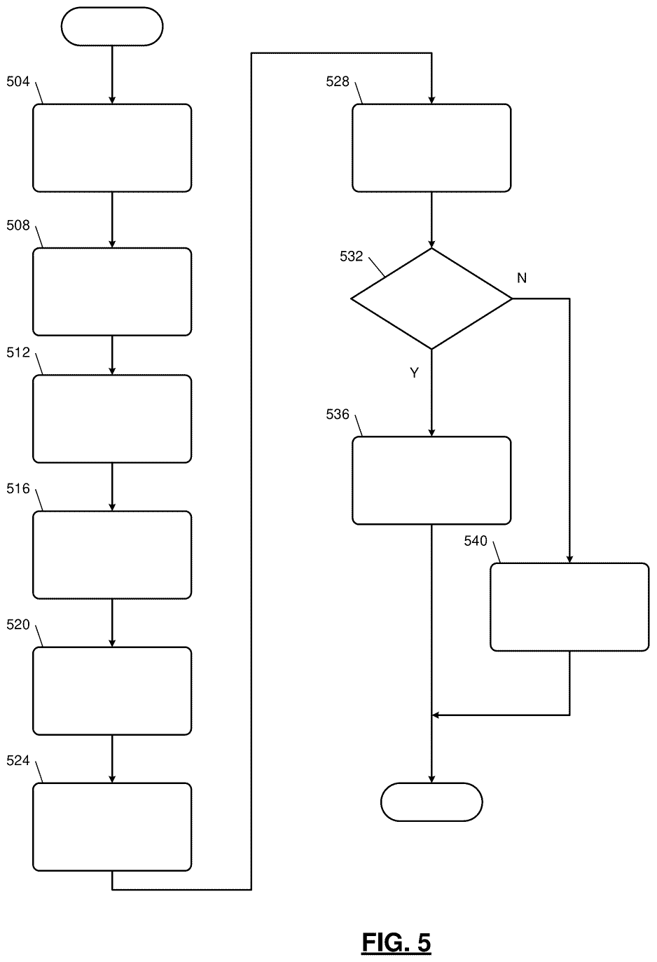

FIG. 5 is a flowchart depicting an example method of testing the sensor(s) under test 320. Control begins with 504 where the input module 304 inputs the sensor data and sensor metadata 308. At 508, the latent space module 312 generates the 3D latent space based on the sensor data and sensor metadata 308.

At 512, the latent representation module 324 generates the latent representation 328 based on the 3D latent space 316. Also at 512, the prediction module 344 generates the one or more time related predictions 340 based on the sensor data and sensor metadata 308.

At 516, the rendering module 332 generates the renderings 336 based on the latent representation 328, the prediction(s) 340, and the sensor metadata 338. The recognition module 356 performs object recognition based on the renderings 336.

At 520, the dynamic data module 360 determines the dynamic data 364 based on the renderings 336. The object tracking module 368 tracks objects using the dynamic data 364. The sensor(s) under test 320 generate output(s) based on the renderings 336 and the dynamic data 364 at 524.

At 528, one or more task modules, such as task module 404, perform one or more tasks on the output(s) of the sensor(s) under test 320. At 532, the fault module 412 determines whether a fault is present in one or more of the sensors under test 320. If 532 is true, at 536 the fault module 412 indicates that a fault is present in a sensor under test, and the remedial action module 416 may take one or more remedial actions. If 532 is false, at 540 the fault module 412 indicates that no fault is present. Control may end after 536 or 540.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. An exterior sensor system for a vehicle, comprising:
an input module configured to input sensor data of an external sensor of the vehicle, the external sensor configured to sense a space outside of the vehicle;
a latent space module configured to generate a three dimensional (3D) space representation of the space based on the input sensor data;
a latent representation module configured to generate a latent 3D representation of the space based on the 3D space representation and using a 3D model;
a prediction module configured to generate one or more predictions for one or more respective times based on the input sensor data;
a rendering module configured to generate one or more renderings of the space based on the latent 3D representation and the one or more predictions; and
a fault module configured to indicate whether a fault is present in the external sensor based on the one or more renderings.

2. The exterior sensor system of claim 1 wherein the input sensor data includes raw data for the external sensor and metadata for the external sensor.

3. The exterior sensor system of claim 2 wherein the metadata includes a configuration of the external sensor and a specification of the external sensor.

4. The exterior sensor system of claim 1 wherein the 3D space representation is ambient condition independent.

5. The exterior sensor system of claim 1 wherein the 3D space representation is sensor independent.

6. The exterior sensor system of claim 1 wherein the 3D space representation is a matrix.

7. The exterior sensor system of claim 1 wherein the rendering module is configured to generate the one or more renderings further based on metadata for the external sensor.

8. The exterior sensor system of claim 7 wherein the metadata includes a location of the external sensor.

9. The exterior sensor system of claim 7 wherein the metadata includes a gesture of the external sensor.

10. The exterior sensor system of claim 1 further comprising a recognition module of the external sensor, the recognition module configured to recognize objects in the one or more renderings.

11. The exterior sensor system of claim 10 wherein the recognition module is configured to recognize objects in the one or more renderings without additional pre-processing of the one or more renderings before the object recognition.

12. The exterior sensor system of claim 1 further comprising a dynamic data module configured to generate dynamic data based on the one or more renderings.

13. The exterior sensor system of claim 12 wherein the dynamic data module is configured to generate the dynamic data further based on a file including dynamic content for at least one of (a) a driving scenario and (b) a traffic scenario.

14. The exterior sensor system of claim 13 wherein the file includes an OpenSCENARIO extensible markup language (XML) file.

15. The exterior sensor system of claim 12 further comprising an object tracking module of the external sensor, the object tracking module configured to track objects using the dynamic data.

16. The exterior sensor system of claim 1 wherein:
the input module is further configured to input second sensor data of a second external sensor of the vehicle, the second external sensor configured to sense the space outside of the vehicle;
the latent space module is further configured to generate a second 3D space representation of the space based on the second input sensor data;
the latent representation module is further configured to generate a second latent 3D representation of the space based on the second 3D space representation and using the 3D model;
the prediction module is further configured to generate one or more second predictions for the one or more respective times based on the second input sensor data;
the rendering module is further configured to generate one or more second renderings of the space based on the second latent 3D representation and the one or more second predictions; and
the fault module is further configured to, concurrently with indicating whether the fault is present in the external sensor, indicate whether a second fault is present in the second external sensor based on the one or more second renderings.

17. The exterior sensor system of claim 1 further comprising at least one of:
a steering control module configured to selectively adjust steering of the vehicle based on the one or more renderings;
an engine control module configured to selectively adjust torque output of an engine of the vehicle based on the one or more renderings;
a brake control module configured to selective adjust braking of the vehicle based on the one or more renderings; and
an inverter module configured to selectively adjust torque output of an electric motor based on the one or more renderings.

18. The exterior sensing system of claim 1 wherein the fault module is configured to indicate that the fault is present in the external sensor when an output of the external sensor generated based on the one or more renderings is different than a predetermined expected output of the external sensor.

19. An exterior sensor system for a vehicle, comprising:
an input module configured to input sensor data of an external sensor of the vehicle, the external sensor configured to sense a space outside of the vehicle;
a latent space module configured to generate a three dimensional (3D) space representation of the space based on the input sensor data;
a latent representation module configured to generate a latent 3D representation of the space based on the 3D space representation and using a 3D model;
a prediction module configured to generate one or more predictions for one or more respective times based on the input sensor data;
a rendering module configured to generate one or more renderings of the space based on the latent 3D representation and the one or more predictions;
a fault module configured to indicate whether a fault is present in the external sensor based on the one or more renderings,
wherein the input sensor data includes raw data for the external sensor and metadata for the external sensor,
wherein the 3D space representation is ambient condition independent and sensor independent,
wherein the rendering module is configured to generate the one or more renderings further based on metadata for the external sensor;
a recognition module of the external sensor, the recognition module configured to recognize objects in the one or more renderings;
a dynamic data module configured to generate dynamic data based on the one or more renderings,
wherein the dynamic data module is configured to generate the dynamic data further based on a file including dynamic content for at least one of (a) a driving scenario and (b) a traffic scenario;
an object tracking module of the external sensor, the object tracking module configured to track objects using the dynamic data; and
at least one of:
a steering control module configured to selectively adjust steering of the vehicle based on the one or more renderings;
an engine control module configured to selectively adjust torque output of an engine of the vehicle based on the one or more renderings;
a brake control module configured to selective adjust braking of the vehicle based on the one or more renderings; and
an inverter module configured to selectively adjust torque output of an electric motor based on the one or more renderings.

20. An exterior sensor method for a vehicle, comprising:
receiving sensor data of an external sensor of the vehicle, the external sensor configured to sense a space outside of the vehicle;
generating a three dimensional (3D) space representation of the space based on the input sensor data;
generating a latent 3D representation of the space based on the 3D space representation and using a 3D model;
generating one or more predictions for one or more respective times based on the input sensor data;
generating one or more renderings of the space based on the latent 3D representation and the one or more predictions; and
indicating whether a fault is present in the external sensor based on the one or more renderings.
